(19) United States
(12) Patent Application Publication
(10) Pub. No.: US 2025/0384617 A1
(43) Pub. Date: Dec. 18, 2025

(54) VOLUMETRIC IMAGING DATA PROCESSING APPARATUS AND METHOD

(71) Applicant: CANON MEDICAL SYSTEMS CORPORATION, Otawara-shi (JP)

(72) Inventor: Morvyn MYLES, Edinburgh (GB)

(73) Assignee: CANON MEDICAL SYSTEMS CORPORATION, Otawara-shi (JP)

(21) Appl. No.: 18/743,364

(22) Filed: Jun. 14, 2024

(51) Int. Cl. G06T 15/08; G06T 15/50

(52) U.S. Cl. CPC G06T 15/08; G06T 15/503; G06T 15/506; G06T 2210/41

(57) ABSTRACT

A volumetric imaging data processing apparatus comprising processing circuitry configured to receive first volume data comprising a plurality of first samples, generate second volume data based on the first volume data, the second volume data comprising a plurality of second samples, a number of the plurality of second samples being less than a number of the plurality of first samples and each of the plurality of second samples of the second volume data having a corresponding first sample of the first volume data, generate adjusted second volume data comprising a plurality of adjusted second regions, each adjusted second region being generated by performing a number of iterations of adjusting a voxel value of a second sample in a second region of the second volume data, wherein in each of the number of iterations, the processing circuitry is configured to determine a plurality of differences between a plurality of first opacity values in a first region of the first volume data and a plurality of corresponding second opacity values in the second region, and adjust the voxel value of the second sample in the second region based on a weighted sum of the plurality of differences.

### FIELD

The present disclosure relates to a volumetric imaging data processing apparatus and a volumetric imaging data processing method.

### BACKGROUND

Volume data acquired by computed tomography (CT) and other X-ray scanners, nuclear magnetic resonance scanners, ultrasound scanners or other medical scanners, can be very large. Some rendering techniques, such as Global Illumination Rendering (GIR), may be performed by a Graphical Processing Unit (GPU) of a computing apparatus. Global Illumination Rendering may be used to add lighting, such as ambient lighting, to a scene derived from volume data, e.g. including multiple structurally-fused volumes. However, a capacity of a memory of the GPU may be limited and as such, it may be difficult to store as much volume data as required by Global Illumination Rendering.

Volume data stored in the memory of the GPU may be kept low by using a tiling process. In this process, a screen is divided in a number of sections and only parts of volume data required by each section of the screen are uploaded into the memory of the GPU. However, Global Illumination Rendering may require multiple render passes, e.g. more than 60, to be produced, before a first user-visible frame can be produced. Uploading the volumes of data to the memory of the GPU more than 60 times would take many seconds, which may affect a frame rate.

A usage of the GPU memory may be reduced by downsizing the volume data. For example, a downsized volume of data may be 50% of a full size volume of data in each axis. Such downsized volume of data may only require an eighth of the memory of the GPU required for the full size volume of data. However, downsizing of the volume data may lead to artefacts in a rendered image representing the volume data.

### DESCRIPTION

Embodiments are now described by way of non-limiting example with reference to the accompanying drawings in which:

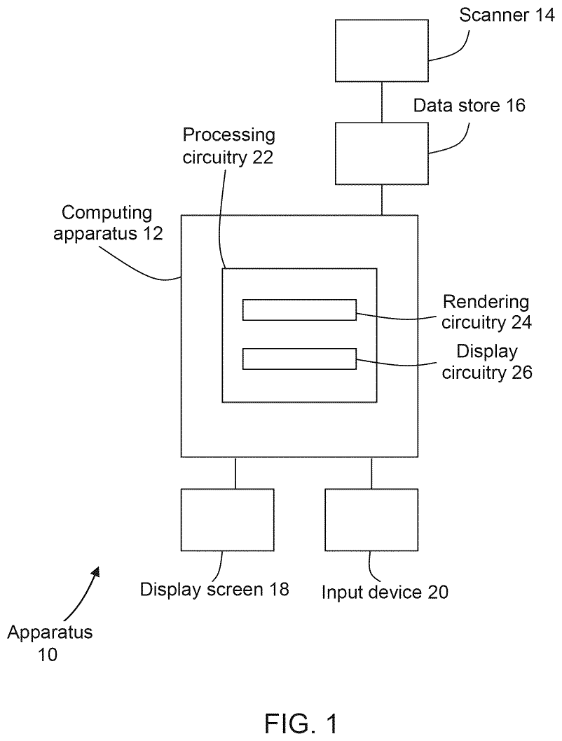

FIG. 1 is a schematic illustration of a volumetric imaging data processing apparatus according to an embodiment;

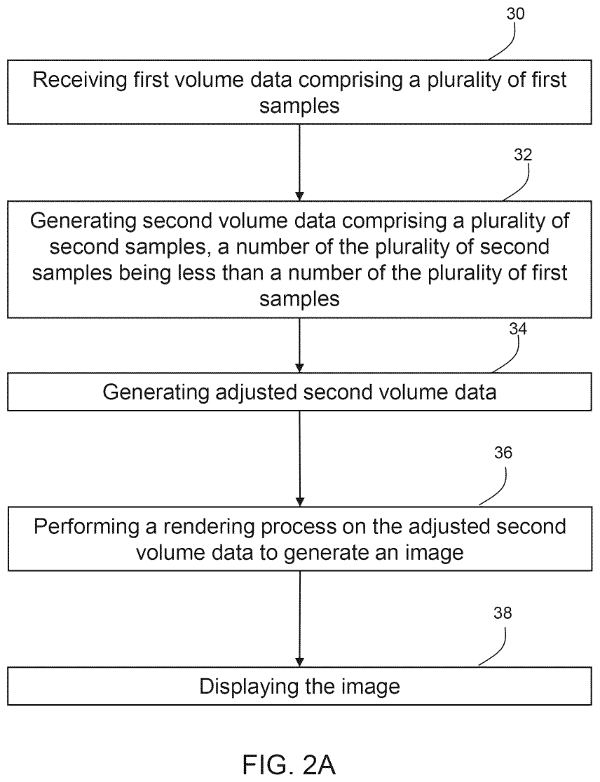

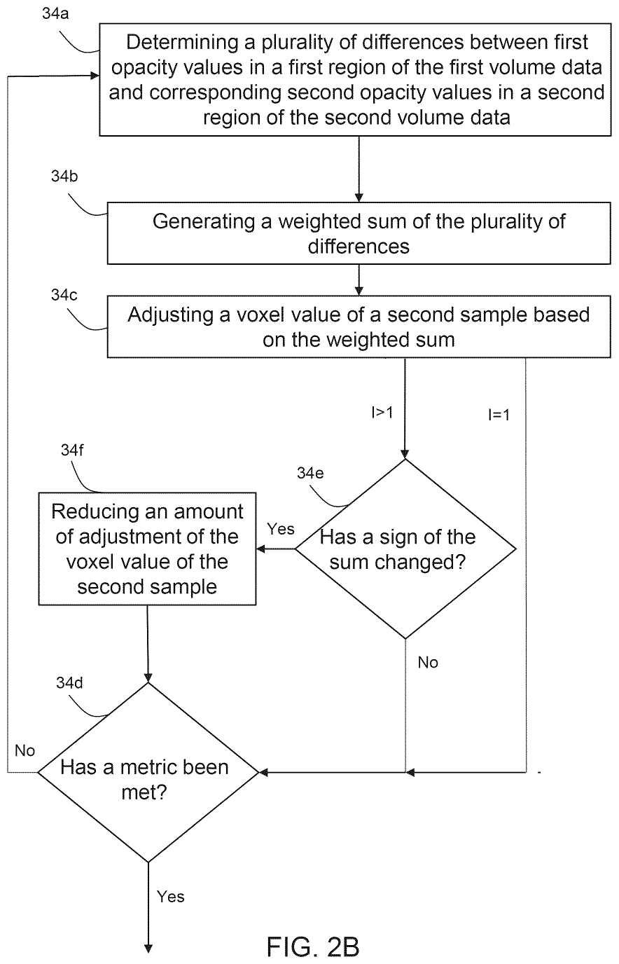

FIG. 2A is a flow chart illustrating in overview a process of an embodiment;

FIG. 2B is a flow chart illustrating further steps in overview of the process of FIG. 2A;

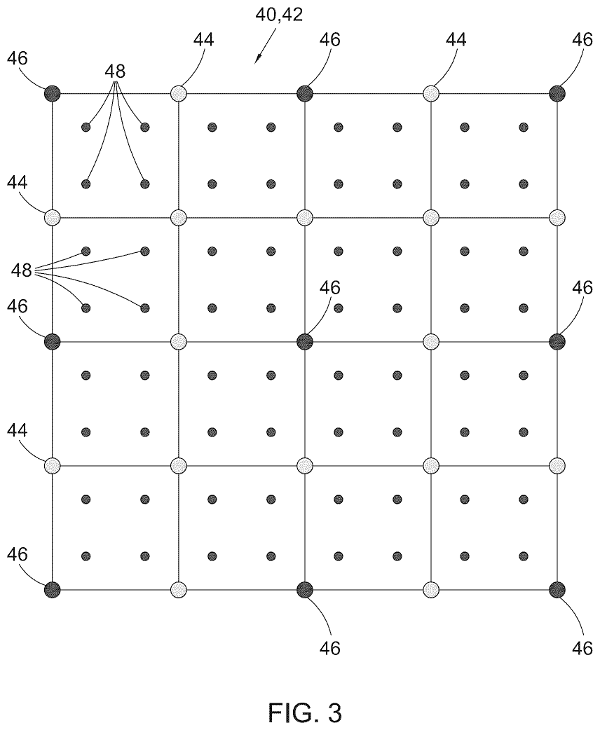

FIG. 3 schematically illustrates an exemplary first region of first volume data, which is overlaid on a corresponding second region of second volume data;

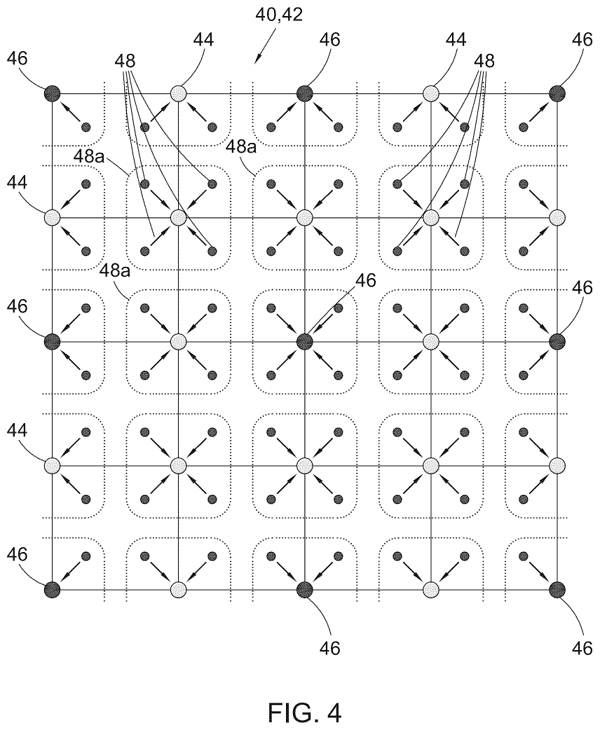

FIG. 4 schematically illustrates an exemplary first region of first volume data, which is overlaid on a second region of second volume data, in which positions at which first and second opacity values are determined are grouped together;

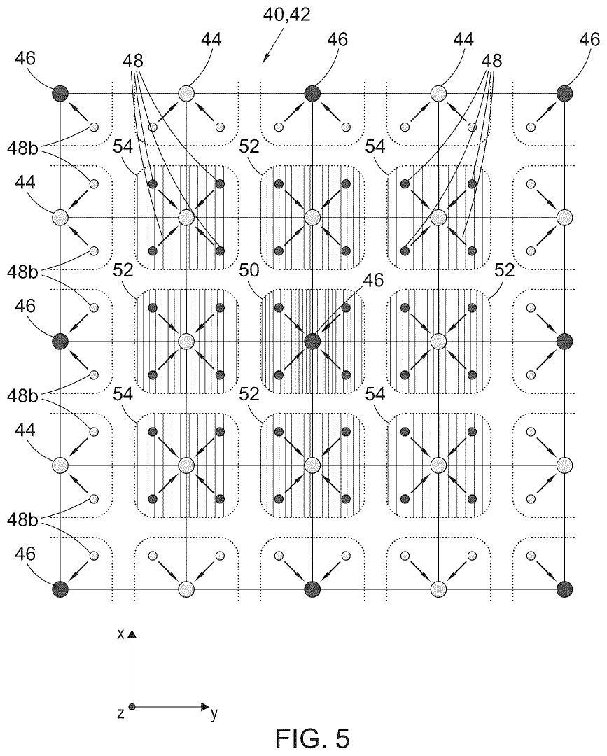

FIG. 5 schematically illustrates an exemplary first region of first volume data, which is overlaid on a second region of second volume data, including a weighting of the sum of differences;

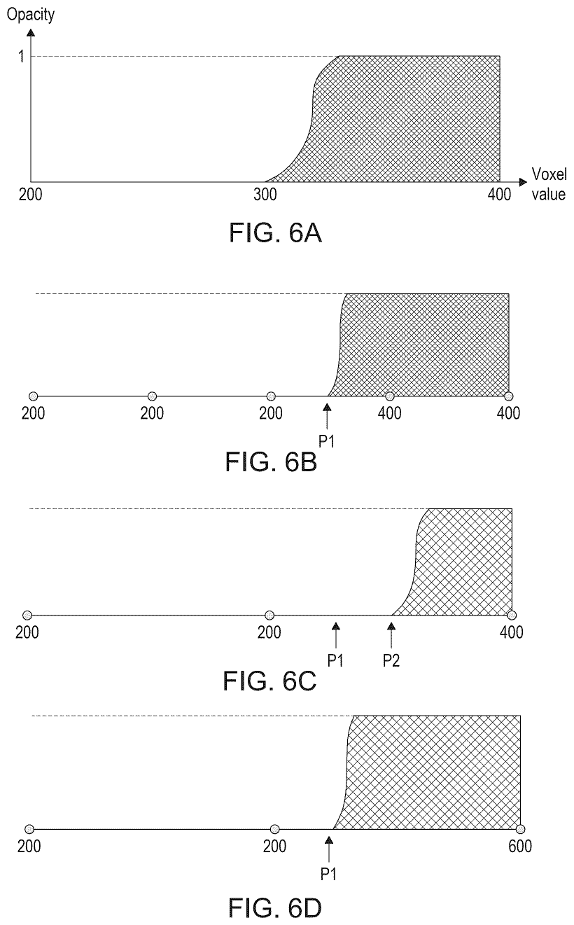

FIG. 6A illustrates an exemplary transfer function, which represents a dependency of an opacity value on a voxel value;

FIG. 6B illustrates an example of the transfer function of FIG. 6A mapped to samples of one-dimensional volume data;

FIG. 6C illustrates an example the transfer function of FIG. 6A mapped to downsized volume data;

FIG. 6D illustrates an example of the transfer function shown in FIG. 6A mapped to adjusted volume data;

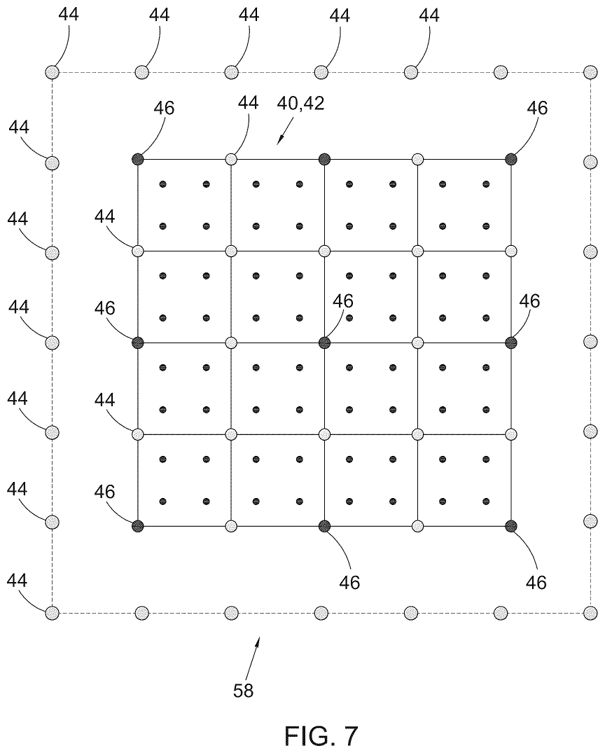

FIG. 7 schematically illustrates an exemplary first region of first volume data, which is overlaid on a second region of second volume data, including a margin region surrounding the first region;

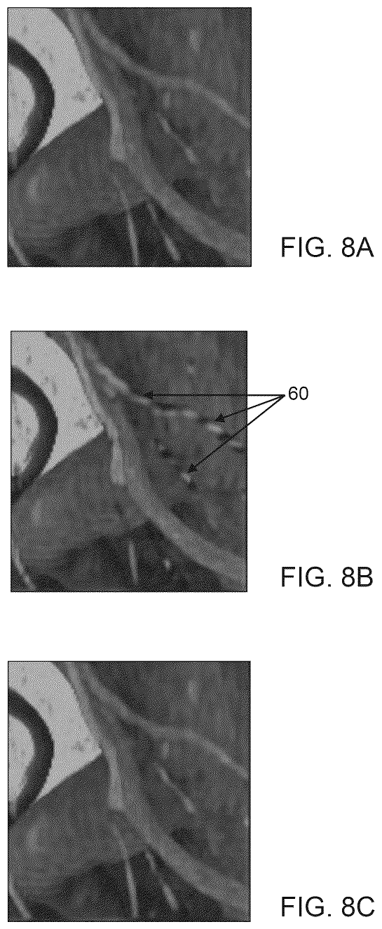

FIG. 8A illustrates a 2D image representing a view of an anatomical region represented by first volume data or full-sized volume data;

FIG. 8B illustrates a 2D image representing a view of an anatomical region represented by second volume data or downsized volume data; and

FIG. 8C illustrates a 2D image representing a view of an anatomical region represented by adjusted second volume data.

Certain embodiments provide a volumetric imaging data processing apparatus comprising processing circuitry configured to receive first volume data comprising a plurality of first samples, generate second volume data based on the first volume data, the second volume data comprising a plurality of second samples, a number of the plurality of second samples being less than a number of the plurality of first samples and each of the plurality of second samples of the second volume data having a corresponding first sample of the first volume data, generate adjusted second volume data comprising a plurality of adjusted second regions, each adjusted second region being generated by performing a number of iterations of adjusting a voxel value of a second sample in a second region of the second volume data, wherein in each of the number of iterations, the processing circuitry is configured to determine a plurality of differences between a plurality of first opacity values in a first region of the first volume data and a plurality of corresponding second opacity values in the second region, and adjust the voxel value of the second sample in the second region based on a weighted sum of the plurality of differences.

Certain embodiments provide a volumetric imaging data processing method comprising receiving first volume data comprising a plurality of first samples, generating second volume data based on the first volume data, the second volume data comprising a plurality of second samples, a number of the plurality of second samples being less than a number of the plurality of first samples and each of the plurality of second samples of the second volume data having a corresponding first sample of the first volume data, generating adjusted second volume data comprising a plurality of adjusted second regions, each adjusted second region being generated by performing a number of iterations of adjusting a voxel value of a second sample in a second region of the second volume data, wherein in each of the number of iterations, the method comprises determining a plurality of differences between a plurality of first opacity values in a first region of the first volume data and a plurality of corresponding second opacity values in the second region, and adjusting the voxel value of the second sample in the second region based on a weighted sum of the plurality of differences.

A volumetric imaging processing apparatus 10 according to an embodiment is schematically illustrated in FIG. 1. The volumetric imaging processing apparatus 10 comprises a computing apparatus 12, which may be provided in the form of a personal computer (PC) or workstation. In this embodiment, the computing apparatus 12 is connected to a scanner 14, e.g. via a data store 16. However, it will be appreciated that in other embodiments, the computing apparatus may not be connected or coupled to any scanner.

The volumetric imaging processing apparatus 10 further comprises one or more display screens 18 and an input device or devices 20, such as a computer keyboard, mouse or trackball.

In the present embodiment, the scanner 14 is a computed tomography (CT) scanner. However, it will be appreciated that in other embodiments the scanner may comprise another medical scanner, such as a nuclear magnetic resonance scanner, an ultrasound scanner or another medical scanner. The scanner 14 is configured to generate volumetric image data of an anatomical region of a patient or other subject.

Volumetric image data comprises a plurality of voxels arranged in a three-dimensional (3D) grid. Each voxel has a voxel value associated with it. The voxel values represent measurements of a physical parameter. For example, in the case of CT scans, the voxel values represent the opacity of those voxels to X-rays, i.e. their X-ray stopping power. X-ray stopping power is measured in Hounsfield units (HUs) which is closely correlated with density (mass per unit volume).

In the present embodiment, volumetric image data sets obtained by the scanner 14 are stored in the data store 16 and subsequently provided to the computing apparatus 12. In an alternative embodiment, volumetric image data sets may be supplied from a remote data store (not shown). The data store 16 or remote data store may comprise any suitable form of memory storage. The following description refers to volumes. However, it will be appreciated that the volumes mentioned below may be understood as comprising volumetric imaging data.

In the present embodiment, the processing circuitry 22 comprises rendering circuitry 24. The rendering circuitry 24 is configured to perform a rendering process to generate one or more images representing volume data. In the present embodiment, the rendering circuitry 24 is configured to perform the rendering process to generate one or more images representing adjusted volume data, which has been generated by the volumetric imaging processing process disclosed herein. Any suitable rendering technique for producing an image representing a view of a scene represented by volume data may be used. For example, global illumination rendering processes, or other advanced image rendering processes, are based on casting rays from virtual light source(s) into volume data, calculating a resulting volumetric array of irradiance values representing irradiance at an array of points in the volume data, and determining an image from the light received at a viewpoint based on the irradiance as a function of position and the passage of light from points in the volume data to the viewpoint.

In the present embodiment, the processing circuitry 22 comprises display circuitry 26 configured to display the image the representing the volume data, e.g. the adjusted volume data, rendered to a user on the display screen 18.

In the present embodiment, the circuitries 22, 24, 26 are each implemented in the GPU by means of a computer program having computer-readable instructions that are executable to perform one or more operations of the volumetric imaging data processing apparatus 10 and/or a volumetric imaging data processing method of an embodiment described herein. However, it will be appreciated that in other embodiments, the circuitries 22, 24, 26 are each implemented in the CPU and/or GPU by means of the computer. In yet other embodiments, the circuitries may be implemented as one or more ASICs (application specific integrated circuits) or FPGAs (field programmable gate arrays). The volumetric imaging data processing method May also be referred to as a volume downsizing method.

The computing apparatus 12 also includes a hard drive and other components of a PC including RAM, ROM, a data bus, an operating system including various device drivers, and hardware devices including a graphics card. Such components are not shown in FIG. 1 for the sake of clarity.

FIG. 2A is a flow chart illustrating in overview a process of an embodiment.

At stage 30, the processing circuitry 22 is configured to receive first volume data. The first volume data comprises a plurality of first samples. The first volume data may also be referred to as an original full-sized volume, original full-sized volume data or a first volume. The first samples may also be referred to as (potentially filtered, e.g. trilinearly) sampled voxel values or voxel positions.

Each first sample represents a voxel on a three-dimensional grid. The voxels of volume data acquired by the scanner 14 are in most cases acquired on a Cartesian grid, i.e. the data points are aligned along three orthogonal axes, which define a volume space. Volumetric imaging data between first samples of the first volume data may be interpolated using an interpolation method, such as a trilinear interpolation method.

At stage 32, the processing circuitry 22 is configured to generate second volume data. The second volume data comprises a plurality of second samples. The processing circuitry 22 is configured to generate the second volume data based on the first volume data. For example, the processing circuitry 22 is configured to generate the second volume data by downsizing the first volume data. In the present embodiment, the first volume data is downsized using a subsampling process. For example, seven first samples of each 2×2×2 region of the first volume data may discarded and a single first sample of each 2×2×2 region of the first volume data may represent a second sample of the second volume data. As such, a number of the second samples of the second volume data is less than a number of the first samples of the first volume data. Each second sample has a corresponding first sample. For example, a voxel value of each second sample corresponds to a voxel value of the corresponding first sample. Volumetric imaging data between second samples of the second volume data may be interpolated using the interpolation method, such as the trilinear interpolation method mentioned above. The second volume data may also be referred to as a downsized volume, downsized volume data or a second volume. The second samples may also be referred to as (potentially filtered, e.g. trilinearly) sampled voxel values or voxel positions.

At stage 34, the processing circuitry 22 is configured to generate adjusted second volume data. The adjusted second volume data comprises a plurality of adjusted second regions.

At stage 36, the processing circuitry 22 is configured to perform a rendering process on the adjusted second volume data. In the present embodiment, the rendering process comprises the global illumination rendering process mentioned above. However, it will be appreciated that in other embodiments, the rendering process may comprise another rendering process. The processing circuitry 22 is configured to generate a two-dimensional (2D) image representing the adjusted second volume data.

At stage 38, the processing circuitry 22 is configured to display the 2D image representing the adjusted second volume data. For example, the display circuitry 26 is configured to display the 2D image representing the adjusted second volume data.

In some embodiments, the processing circuitry 22 is configured to determine at stage 30 whether the steps of generating the second volume data, as described in relation to stage 32, and generating the adjusted second volume data, as described in relation to stage 34, need to be performed. For example, the processing circuitry 22 may be configured to determine whether these steps need to be performed based on a first transfer function, e.g. using a heuristic method. The processing circuitry 22 is configured to use the first transfer function to map each voxel value of the first samples to at least a first opacity value. For example, a first transfer function representing a shallow increase of the opacity values relative to the voxel value of the first samples may be indicative that the steps of generating the second volume data and generating the adjusted second volume data do not need to be performed. When the processing circuitry 22 determines that the steps of generating the second volume data and generating the adjusted second volume data do not need to be performed, the processing circuitry 22 is configured to perform a rendering process on the first volume data at stage 36, e.g. to generate a 2D image representing the first volume data. At stage 38, the processing circuitry 22 is configured to display the 2D image representing the first volume data.

FIG. 2B is a flow chart illustrating further steps in overview of the process of shown in FIG. 2A. The processing circuitry 22 is configured to generate the adjusted second regions. Each adjusted second region is generated by performing a number of iterations I of adjusting a voxel value of a second sample in a second region. In each iteration I, the processing circuitry 22 is configured to perform one or more of the further steps shown in FIG. 2B. The further steps illustrated in FIG. 2B may be part of a hill climbing optimisation process or other iterative process.

At stage 34a, the processing circuitry 22 is configured to determine a plurality of differences between a plurality of first opacity values in a first region and corresponding second opacity values in the second region. The first region may also be referred to as a sub-region.

In a first iteration, the second opacity values in the second region correspond to current second opacity values. In each subsequent iteration, the second opacity values correspond to second opacity values that have been adjusted in a previous iteration. For example, as will be described below, when the voxel value of the second sample in the second region is adjusted, one or more of the second opacity values are also adjusted. The second region comprising the adjusted voxel value may also be referred to as an adjusted second region, e.g. of adjusted second volume data. The adjusted second volume data may also be referred to as a newly-modified volume or newly-modified volume data.

In the first iteration, e.g. prior to stage 34a, the processing circuitry 22 is configured to detect whether the first opacity values in the first region are the same. For example, the processing circuitry 22 is configured to determine each first opacity values at a first position between neighbouring first samples in the first region. The determination of the first opacity values will be described in more detail in the following description.

In the present embodiment, the processing circuitry 22 is configured to determine the first opacity values at a plurality of first positions in each first region. Alternatively, the processing circuitry 22 may be configured to determine the first opacity values at a plurality of positions in the first volume data. For example, each first opacity value in the first region each may comprise a fully transparent opacity value, such as zero, or a fully opaque opacity value, such as one. In response to a determination that the first opacity values in the first region are the same, the processing circuitry 22 is configured to maintain a current value of the second sample. As such, the voxel value of the second sample is frozen at its current value. The processing circuitry 22 can then mark the second sample as no longer taking part in the process. This may avoid adjusting a voxel value of a second sample in a region of the first and/or second volume data that represent air or a solid (e.g. opaque) internal anatomical structure. This may increase an execution speed of the process.

FIG. 3 schematically illustrates an exemplary first region 40 of the first volume data, which is overlaid on a corresponding second region 42 of the second volume data. The first region 40 of the first volume data and the corresponding second region 42 of the second volume data are each shown in two dimensions. However, it will be appreciated that the process disclosed herein is performed in three dimensions.

In the present embodiment, a size of the first region 40 is 5×5×5. For example, the first region 40 comprises five first samples 44 in each of the three dimension of the first region 40. A size of the second region 42 is 3×3×3. For example, the second region 42 comprises three second samples 46 in each of the three dimensions of the second region 42. In FIG. 3, the second samples 46 are shown as overlaying corresponding first sample. The second region 42 may also be referred to as a footprint.

It can be seen in FIG. 3, that the subsampling process applied to the first volume data to generate the second volume data has removed every second first sample 44 in each of the three dimensions of the first volume data. It will be appreciated that in other embodiments, the subsampling process may remove more or less than every second first sample.

FIG. 3 also shows the plurality of first positions between neighbouring first samples 44 mentioned above and a plurality of second positions between neighbouring second samples 46. The first positions in the first region 40 and the second positions in the second region 42 of are the same. For sake of clarity, the first and second positions are indicated by the same reference numeral 48 in FIG. 3. The positions 48 may also be referred to as alpha probe positions.

In the embodiment shown, each 2×2×2 region of the first region 40 comprises eight first positions 48. However, it will be appreciated that in other embodiments, there may be more or less than first eight positions in each 2×2×2 region of the first region.

In the embodiment shown in FIG. 3, the positions 48 are arranged to be equidistant relative to each other. Each of the first and second samples 44, 46 in the first and second region 40, 42, respectively, is surrounded by a number of the positions 48. The number of positions 48 are arranged to be equidistant relative to each of the first and second samples 44, 46. In the embodiment shown in FIG. 3, each of the first and second samples 44, 46 in the first and second region 40, 42, respectively, is surrounded by a four positions 48. However, it will be appreciated that in other embodiments, each of the first and second samples may be surrounded by more or less than four positions. The positions 48 may be arranged to define a grid in the first and second regions 40, 42. The processing circuitry 22 is configured to determine a plurality of differences between first opacity values at the first positions 48 and corresponding second opacity values at the second positions 48.

In some embodiments, the processing circuitry 22 is configured to determine the first opacity values in the first region 40 based on the first transfer function applied to the first samples 44 in the first region 40, e.g. the first volume data. The first transfer function may comprise a colour and/or opacity transfer function. In examples, where an opacity transfer function is used, the first transfer function may represent a slope or ramp between an opacity value of zero and an opacity value of one. However, it will be appreciated that in other embodiments, another transfer function and/or more a complex transfer function may be used. As described above, the first transfer maps each voxel value of the first samples 44 to a first opacity value. As mentioned above, the global illumination rendering process calculates a volumetric array of irradiance values representing irradiance at an array of points in the volume data, but does not use any color information of the first volume data. Although a transmittance transfer function is applied to the first volume data, which represent a tinting of light as it passes through the first volume data, this transfer function can have a very small effect on the lighting to be applied compared to the opacity transfer function. Additionally, when a first opacity value matches a second opacity values, then corresponding transmittance values of the first and second volume data may also match. Accordingly, in the process disclosed herein only the opacity values of the first and second volume data may be evaluated.

The processing circuitry 22 is also configured to determine the first opacity values based on the interpolation, e.g. the trilinear interpolation method, used to generate first volumetric imaging data between the first samples 44, as described above. The step of determining the first opacity values may also be referred to as generating alpha probes or solidity probes in the first volume data. The processing circuitry 22 is configured to determine a first opacity value at each first position 48 in the first region 40.

The processing circuitry 22 is configured to determine the second opacity values in the second region 42 based on a second transfer function applied to the second samples 46 in the second region 42, e.g. the second volume data. The first and second transfer functions are the same. The processing circuitry 22 is also configured to determine the second opacity values based on the interpolation, e.g. the trilinear interpolation, used to generate second volumetric imaging data between the second samples 46, as described above. The step of determining the second opacity values may also be referred to as generating alpha probes or solidity probes in the second volume data.

The processing circuitry 22 is configured to determine a second opacity value at each second position 48 in the second region 42. The first and second opacity values may each also be referred to as alpha values.

In some embodiment, each difference comprises a subtracted difference between a first opacity value and a corresponding second opacity value, e.g. at corresponding first and second positions 48.

In some embodiments, each difference comprises a subtracted difference between an average value of a group of first opacity values and an average value of a corresponding group of second opacity values, which will be described below. This may result in an increased execution speed of the process described herein and/or reduce a required memory capacity of the GPU to store the differences.

FIG. 4 schematically illustrates the exemplary first region 40 of the first volume data, which is overlaid on a second region 42 of the second volume data. In this embodiment, each first sample 44 is associated with a group 48a of first opacity values. For example, a number of first opacity values determined at first positions 48 that surround each first sample 44 are grouped together. A number of second opacity values at second positions 48 corresponding to the first positions 48 that surround each first sample 44 are also grouped together. The groups 48a are indicated by the dashed boxes in FIG. 4.

The processing circuitry 22 is configured to average the first opacity values in each group 48a associated with a first sample 44. The processing circuitry 22 is configured to average the second opacity values in each corresponding group.

In some embodiments, the first and second transfer functions that are used to map the voxel values of the first and second samples to first and second opacity values, respectively, as described above, may each be represented by a slope, curve or ramp of the opacity value from zero to one. In other embodiments, the first and second transfer function that are used to map the voxel values of the first and second samples to first and second opacity values, respectively, may be more complex than the slope, curve or ramp of the opacity values from zero to one. For example, a part of each of the first and second the transfer functions may decrease from one to zero or the like. In such other embodiments, each difference comprises a gradient between a first opacity value of the first transfer function at a first position 48 in the first region 40 and a second opacity value of the second transfer function at a corresponding second position 48 in the second region 42. In such embodiments, the processing circuitry 22 is configured to determine a gradient between a first opacity value of the first transfer function and a second opacity value of the second transfer function at corresponding first and second positions 48 in the first and second regions 40, 42. The interpolation of volumetric imaging data between the first samples 44 and the interpolation of the volumetric imaging data between the second samples 46 may affect the first and second opacity values, respectively. The processing circuitry 22 may be configured to determine the gradient between the first opacity value of the first transfer function at the first position 48 in the first region 40 and the second opacity value of the second transfer function at the corresponding second position 48 in the second region 42 based on the interpolation of volumetric imaging data between the first samples 44 and the interpolation of the volumetric imaging data between the second samples 46.

Referring to FIG. 2B, at stage 34b, the processing circuitry 22 is configured to generate a weighted sum of the plurality of differences. The generation of the weighted sum will be further described with reference to FIG. 5.

FIG. 5 schematically illustrates the exemplary first region 40 of the first volume data, which is overlaid on the second region 42 of the second volume data, including a weighting of the sum of differences.

In some embodiments, a weighting of the weighted sum of differences is based on a position in the first and second regions 40, 42 at which each of the plurality of differences is determined relative to the second sample 46 having the voxel value to be adjusted. As such, the differences are weighted according to weights used during the interpolation of volumetric imaging data between the second samples 46. These weights may also be referred to as trilinear filtering weights. In this example, a voxel value of the second sample 46 in the centre of the second region 42 is to be adjusted. A distance between the central second sample 46 and one or more positions at which the differences have been determined may be referred to as Manhattan distance.

In this example, a first difference determined based on a first group 50 of first and second opacity values is assigned the highest weighting. The first group 50 of first and second opacity values have been determined at corresponding first and second positions 48 surrounding the central second sample 46.

A second difference determined based on an adjacent second group 52 of first and second opacity values is assigned a lower weighting relative to the first difference. The second group comprises first and second opacity values that have been determined at positions that match with positions of the first and second opacity values of the first group 50 in at least two directions, e.g. an x-, y-, or z-direction, of the 3D grid of the first and second volume data. The x-, y- and z-directions are indicated in FIG. 5.

A third difference determined based on a diagonally adjacent third group 54 of first and second opacity values is assigned a lower weighting relative to the second difference. The third group comprises first and second opacity values that have been determined at positions that match with positions of the first and second opacity values of the first group 50 in at least one direction e.g. an x-, y-, or z-direction, of the 3D grid of the first and second volume data.

A fourth difference determined based on a diagonally adjacent fourth group (not shown in FIG. 5 for sake of clarity) of first and second opacity values is assigned a lower weighting relative to the third difference. The fourth group comprises first and second opacity values that have been determined at positions that do not match with positions of the first and second opacity values of the first group 50 in the x-, y-, and z-direction of the 3D grid of the first and second volume data.

The processing circuitry 22 is configured to assign a weighting to each of the differences. Although the above description mentions groups of first and second opacity values it will be appreciated that the same weighting can be assigned to each of the differences based on a position 48 at which the difference between corresponding first and second opacity values has been determined.

The processing circuitry 22 is configured to assign a weighting of zero to at least one of the differences determined at a position 48 adjacent to at least one other of the plurality of second samples 46 in the second region 42. Each position adjacent another second sample 46 is indicated in FIG. 5 by reference numeral 48b. These positions 48b are the furthest from the central second sample 46 in the second region 42. For example, these positions 48b include positions that are ⅞ths of a distance to an adjacent other second sample 46. By assigning a weighting of zero to at least one of the differences determined at a position 48 adjacent to at least one other of the plurality of second samples 46 in the second region, an execution speed for determining the weighted sum of differences may be increased.

In some embodiments, the weighting of the weighted sum of differences is based on a deviation between a first opacity value and a corresponding second opacity value. In such embodiments, a magnitude of the weighting assigned to at least one or each of the differences may be squared.

Referring to FIG. 2B, at stage 34c, the processing circuitry 22 is configured to adjust a voxel value of the second sample 46 based the weighted sum of the differences. As mentioned above, the processing circuitry 22 is configured to adjust the voxel value of the central second sample 46 in the second region 42. A second sample comprising an adjusted voxel value may also be referred to as downsized voxel. An effect of adjusting the voxel value of the second sample will be described in more detail in relation to FIGS. 6A to 6D.

FIG. 6A illustrates an exemplary transfer function, which represents a dependency of an opacity value on a voxel value. In this embodiment, the opacity value ranges from zero to one. The transfer function shown in FIG. 6A is representative of a slope, curve or ramp of the opacity value from zero to one.

FIG. 6B illustrates an example of the transfer function shown in FIG. 6A mapped to samples of one-dimensional volume data. Each sample is indicated by a circle in FIG. 6B. Each value below each circle is representative of an exemplary voxel value of each sample. It can be seen that the samples having a voxel value of 400 are mapped to an opacity value of one.

As mentioned above, volumetric imaging data between the samples has been interpolated using the interpolation method. For example, volumetric imaging data in the middle between the sample having a voxel value of 200 and the sample having a voxel value of 400 has been interpolated to 300. At this position P1, the opacity value starts to increase from zero to one.

FIG. 6C illustrates an example of the transfer function shown in FIG. 6A mapped to downsized volume data. The downsized volume data has been generated by applying the subsampling process to the one-dimensional volume data shown in FIG. 6B. The volumetric imaging data between the samples has been interpolated, e.g. using the interpolation method mentioned above. It can be seen that a position at which the opacity value starts to increase from zero to one, e.g. a position representative of the voxel value of 300, has shifted relative to that indicated in FIG. 6B. This shifted position is indicated in FIG. 6C by reference numeral P2. If a rendering process, such as a global illumination rendering process, is used on the downsized volume data shown in FIG. 6C, some of the light casted from the virtual light source(s) into the volume data, which may be visible, when rendering the volume data shown in FIG. 6B, may not be visible, when rendering the downsized volume data shown in FIG. 6C. For example, when rendering volumetric imaging data at position P1 in FIG. 6B, which may be visible, the lighting information for that point may not be found, as it was placed at position P2, when rendering a lighting pass of the downsized volume data shown in FIG. 6C. This may result in artefacts in the 2D image of the rendered downsized volume data.

FIG. 6D illustrates an example of the transfer function shown in FIG. 6A mapped to adjusted volume data. In this example, a voxel value of the sample having a voxel value 400 in FIG. 6C has been increased to 600. It can be seen that the increase of the voxel value shifts the position P2 at which the opacity value starts to increase from zero to one in FIG. 6C back to the position P1. In the example shown in FIG. 6D, the position P1 at which the opacity value starts to increase from zero to one has been shifted without adding additional samples. This may prevent or reduce in artefacts in the 2D image of the rendered adjusted volume data.

The processing circuitry 22 is configured to adjust the voxel value of the second sample 46 based on a sign of the weighted sum of differences. For example, if the sign of the weighted sum is positive, the processing circuitry 22 can be configured to increase the voxel value of the second sample 46. If the sign of the weighted sum is negative, the processing circuitry 22 can be configured to decrease the voxel value of the second sample 46.

In a first iteration I, e.g. I=1, the processing circuitry 22 is configured to adjust the voxel value of the second sample by an amount. The amount may also be referred to as jump or jump size.

In some embodiment, the processing circuitry is configured to only adjust the voxel value of the second sample 46 in the second region 42, e.g. when a combined total of the differences is above a threshold value. In this embodiment, each difference comprises an absolute difference. The threshold value can be zero or a value close to zero. The processing circuitry 22 is configured to maintain a current voxel value of the second sample of in the second region 42, e.g. when, in at least one of the number of iterations, the combined total of the differences is below or equals the threshold value. For example, when the combined total of the differences between corresponding first and second opacity values is below or equals the threshold value, the second opacity values in a particular second region 42 are considered to correspond, e.g. substantially correspond, to the first opacity values in the correspond first region 40. As such, the voxel value of the second sample is frozen at its current value in the particular second region 42. The processing circuitry 22 can then mark the second sample as no longer taking part in the process. This may increase an execution speed of the process.

When the current voxel value of the second sample 46 in the second region 42 is maintained or frozen, the processing circuitry 22 is configured to maintain or freeze one or more second opacity values associated with the second sample. For example, the second opacity values associated with the second sample 42 may comprise one or more second opacity values that were determined at one or more positions surrounding the second sample, such as those in the first group 50 shown in FIG. 5.

In embodiments, where a voxel value of two or more adjacent second samples 46 is maintained or frozen, the processing circuitry 22 is configured to maintain or freeze one or more second opacity values, which are determined between the two or more adjacent second samples of the plurality of second samples. In some examples, a voxel value of four adjacent second samples 46 may be maintained or frozen, e.g. subsequent to the process disclosed herein being performed on one or more second regions including the four adjacent samples 46. The four adjacent second samples 46 form a square group in a second region or one or more overlapping second regions. In such examples, one or more second opacity values that have been determined at one or more positions 48 between the four adjacent second samples 46 may be maintained or frozen. In some examples, a voxel value of eight adjacent second samples may be maintained or frozen, e.g. subsequent to the process disclosed herein being performed on one or more second regions including the eight adjacent samples. The eight adjacent second samples form a cubic group in a second region or one or more overlapping second regions. In such examples, one or more second opacity values that have been determined at one or more positions 48 between the eight adjacent second samples 46 may be maintained or frozen. When the processing circuitry maintains or freezes one or more second opacity values at one or more positions in a current second region, these second opacity values are excluded from being used in the determination of the plurality of differences, e.g. in a second region that is adjacent to the current second region, in the current and subsequent iterations. This may reduce a required memory capacity of the GPU to store the differences and/or increase an execution speed of the process.

Referring back to FIG. 2B, at stage 34d, the processing circuitry 22 is configured to determine whether a predetermined metric has been met. In some embodiments, the predetermined metric comprises a quality metric. For example, the predetermined metric may be indicative that one or more of the differences between the first opacity values in the first region 40 and the second opacity values in the second region 42 are minimised, zero or remain the same in two or more iterations. For example, in the case of a nuclear magnetic resonance scans, the predetermined metric may comprise the quality metric. Alternatively, the predetermined metric may correspond to a predetermined amount of adjustment to be applied to the voxel values of the second sample. For example, in the case of CT scans, the predetermined amount of adjustment may comprise a selected number of Hounsfield units, such as one Hounsfield units. However, it will be appreciated that in other embodiments, the selected number of Hounsfield units may be larger than one.

In response to a determination that the predetermined metric has been met, the process proceeds to stage 36, which has been described above in relation to FIG. 2A. For example, in response to the determination that the predetermined metric has been met, the processing circuitry 22 is configured to maintain a current voxel value of the second sample.

In response to a determination that the predetermined metric has not been met, the process returns to stage 34a. For example, in response to the determination that the predetermined metric has not been met, the processing circuitry 22 is configured to perform a next iteration of adjusting the voxel value of the second sample.

In the first iteration I, the process proceeds from stage 34c to stage 34d, as shown in FIG. 2B. In a subsequent iteration I, e.g. I>1, at stage 34e, the processing circuitry 22 is configured to determine whether a sign of the weighted sum of differences has changed, e.g. compared to a sign of the weighted sum of differences that has been generated in the current iteration. In response to a determination that the sign of the weighted sum of differences has changed, the process continues to stage 34f. In response to a determination that that the sign of the weighted sum of differences has not changed, the process continues to stage 34d.

At stage 34f, the processing circuitry 22 is configured to reduce an amount of adjustment to be applied to the voxel value of the second sample in a next iteration, e.g. relative to an amount of adjustment applied to the voxel value of the second sample in the current iteration. For example, in the first iteration, the processing circuitry 22 is configured to adjust the voxel value of the second sample by the amount in a first direction. In a subsequent iteration, the processing circuitry 22 is configured to adjust a voxel value of a corresponding second sample of an adjusted second region that has been generated in the first iteration. In the subsequent iteration, the processing circuitry 22 is configured to adjust the voxel value of the corresponding second sample of the adjusted second region by an amount that is reduced relative to the amount that has been used in the first iteration. As such, in each subsequent, the processing circuitry 22 is configured to decrease an amount of adjustment applied to the voxel value of the second sample relative an amount that has been used in a previous iteration.

In the subsequent iteration, the processing circuitry 22 is configured to adjust the voxel value of the corresponding second sample of the adjusted second region by the amount in a second direction. The second direction is opposite to the first direction. The first direction is indicative of at least one of an increase or decrease of the voxel value of the second sample. The second direction is indicative of at least one other of the increase or decrease of the voxel value of the second sample.

Referring to FIGS. 2A and 2B, in some embodiments, the processing circuitry 22 is configured to successively receive a first region, generate a second region based on the first region and to generate an adjusted second region by performing the number of iterations of adjusting a voxel value of a second sample in the second region. In such embodiments, the first volume data comprises a plurality of first regions. This may allow for each first region to be uploaded into the GPU and the second region and the adjusted second region to be generated therein. The processing circuitry is configured to form the adjusted second volume data on a region-by region basis (or brick-by-brick basis). For example, the adjusted second volume data may be formed in the GPU on the region-by-region basis. This may allow the process to be performed in the GPU, e.g. when a usage of the memory of the GPU is required to be low. In such embodiments, each first region 40 is surrounded by a margin region 58, which comprises one or more first samples from one or more neighbouring first regions.

FIG. 7 schematically illustrates an exemplary first region of first volume data, which is overlaid on a second region of second volume data, including a margin region surrounding the first region. The margin region may allow for an overlap between one or more first samples of a current first region and an adjacent first region, as first samples from the adjacent region can affect the generation of a second region and/or an adjusted second region based on the current first region. For example, the margin region may be such that the current first region and the adjacent region overlap by about four first samples. However, it will be appreciated that in other embodiments, the margin region may be such that the current first region and the adjacent region overlap by more or less than four first samples. For sake of clarity, the margin region 58 is shown in FIG. 7 to allow for an overlap with one first sample of an adjacent first region. Alternatively, the processing circuitry 22 may be configured to re-use one or more voxel values of one or more first samples from a previously received adjacent first region.

It will be appreciated that in other embodiments, all of the first regions, e.g. the first volume data, may be simultaneously received. In such other embodiments, a plurality of second regions may be simultaneously generated and/or a plurality of adjusted second regions may be simultaneously generated.

FIG. 8A illustrates a 2D image representing a view of an anatomical region represented by first volume data or full-sized volume data. In the example shown in FIG. 8A, the anatomical region comprises a number of arteries and veins passing over a part of the iliac arteries. It will be appreciated that the anatomical region described herein is not limited to comprising arteries and veins and that in other embodiments, the anatomical region may comprise a different anatomical structure or region. The 2D image shown in FIG. 8A has been produced by applying a global rendering process to the first volume data.

FIG. 8B illustrates a 2D image representing a view of an anatomical region represented by second volume data or downsized volume data. As mentioned above, the second volume data may be generated based on the first volume data by using the subsampling process mentioned above. The 2D image shown in FIG. 8B has been generated by applying a global illumination rendering process to the second volume data. As can be seen in FIG. 8B, a number of artefacts 60 are present in the 2D image.

As mentioned above, if a rendering process, such as a global illumination rendering process, is used on downsized volume data, some of the light casted from the virtual light source(s) into the volume data, which may be visible, when rendering the full-size volume data, may not be visible, when rendering the downsized volume data. This may result in artefacts in the 2D image representing the rendered downsized volume data.

FIG. 8C illustrates a 2D image representing a view of an anatomical region represented by adjusted second volume data. The adjusted second volume data has been generated using the process described herein. The 2D image shown in FIG. 8C has been produced by applying a global rendering process to the adjusted second volume data. It can be seen in FIG. 8C that the process described herein may allow for a reduction of artefacts in the rendered 2D image.

Certain embodiments provide a volumetric imaging data processing apparatus comprising processing circuitry configured to receive first volume data comprising a plurality of first samples, generate second volume data based on the first volume data, the second volume data comprising a plurality of second samples, a number of the plurality of second samples being less than a number of the plurality of first samples and each of the plurality of second samples of the second volume data having a corresponding first sample of the first volume data, generate adjusted second volume data comprising a plurality of adjusted second regions, each adjusted second region being generated by performing a number of iterations of adjusting a voxel value of a second sample in a second region of the second volume data, wherein in each of the number of iterations, the processing circuitry is configured to determine a plurality of differences between a plurality of first opacity values in a first region of the first volume data and a plurality of corresponding second opacity values in the second region, and adjust the voxel value of the second sample in the second region based on a weighted sum of the plurality of differences.

The processing circuitry may be configured to determine the plurality of first opacity values in the first region, e.g. based on a first transfer function applied to the plurality of first samples and an interpolation used to generate first volumetric imaging data between the plurality of first samples. The processing circuitry may be configured to determine the plurality of second opacity values in second region, e.g. based on a second transfer function applied to the plurality of second samples and an interpolation used to generate second volumetric imaging data between the plurality of second samples.

Each difference of the plurality of differences may comprise a subtracted difference between an average value of a group of the plurality of first opacity values and an average value of a corresponding group of the plurality of second opacity values.

Each difference of the plurality of differences may comprises a subtracted difference between at least one first opacity value of the plurality of first opacity values and at least one corresponding second opacity value of the second plurality of opacity values.

Each of the plurality of differences may comprise a gradient between a first opacity value of a first transfer function at a first position in the first region and a second opacity value of a second transfer function at a second position in the second region. The second position in the second region may correspond to the first position in the first region.

A weighting of the weighted sum of differences may be based on at least one of: a position in the first and second regions at which each of the plurality of differences is determined relative to the second sample, and/or a deviation between a first opacity value of the plurality of first opacity values and a corresponding second opacity value of the plurality of second opacity values.

The processing circuitry may be configured to assign a weighting of zero to at least one of the plurality of differences determined at a position adjacent to at least one other second sample in the second region.

The processing circuitry may configured to adjust the voxel value of the second sample, e.g. based on a sign of the weighted sum of differences. The processing circuitry may configured to adjust the voxel value of the second sample by increasing or decreasing the voxel value of the second sample, e.g. based on the sign of the weighted sum of differences. For example, the processing circuitry may configured to increase or decrease the voxel value of the second sample, e.g. based on the sign of the weighted sum of differences.

In each iteration, the processing circuitry may be configured to adjust the voxel value of the second sample relative to a previous voxel value of the second sample.

In a first iteration, the processing circuitry may be configured to adjust the voxel value of the second sample by an amount. In the first iteration, the processing circuitry may be configured to determine whether a predetermined metric has been met. In response to a determination that the predetermined metric has been met, the processing circuitry may be configured to maintain a current voxel value of the second sample. Alternatively, in response to a determination that the predetermined metric has not been met, the processing circuitry may be configured to perform a next iteration of adjusting a voxel value of the second sample.

In each subsequent iteration, the processing circuitry may be configured to determine whether a sign of the weighted sum of the plurality of differences has changed. In response to a determination that the sign of the weighted sum of the plurality of differences has changed, the processing circuitry may be configured to reduce an amount of adjustment to be applied to the voxel value of the second sample in a next iteration relative to an amount of adjustment applied to the voxel value of the second sample in a current iteration.

In each subsequent iteration, the processing circuitry may be configured to determine whether a predetermined metric has been met. In response to a determination that the predetermined metric has been met, the processing circuitry may be configured to maintain a current voxel value of the second sample. Alternatively, in response to a determination that the predetermined metric has not been met, the processing circuitry may be configured to perform a next iteration of adjusting the voxel value of the second sample.

The processing circuitry may be configured to only adjust the voxel value of the second sample, e.g. when a combined total of the plurality of differences is above a threshold value. Each of the plurality of differences may comprise an absolute difference. The processing circuitry may be configured to maintain a current voxel value of the second sample, e.g. when, in at least one of the number of iterations, each of the plurality of differences is below or equals the threshold value.

For example, when the current voxel value of the second sample is maintained, the processing circuitry may be configured to maintain one or more of the plurality of second opacity values associated with the second sample.

For example, when a voxel value of two or more adjacent second samples of the plurality of second samples is maintained, the processing circuitry may be configured to maintain one or more of the plurality of second opacity values. The one or more of the plurality of second opacity values may be at one or more positions between the two or more adjacent second samples of the plurality of second samples.

The processing circuitry may be configured to detect whether the plurality of first opacity values in the first region are the same. In response to a determination that the plurality of first opacity values in the first region are the same, the processing circuitry may be configured to maintain the voxel value of the second sample in the second region. The plurality of first opacity values in the first region may each comprise a fully transparent opacity value or a fully opaque opacity value.

The processing circuitry may be configured to perform a rendering process on the adjusted second volume data.

The first volume data may comprise a plurality of first regions. The processing circuitry may be configured to successively receive at least one of the plurality of first regions, generate a second region based on the at least one of the plurality of first regions, and generate an adjusted second region by performing the number of iterations of adjusting a voxel value of a second sample in the second region.

Each of the plurality of first regions may be surrounded by a margin region. The margin region may comprise one or more first samples from one or more neighbouring first regions of the plurality of first regions.

Certain embodiments provide a volumetric imaging data processing method comprising receiving first volume data comprising a plurality of first samples, generating second volume data based on the first volume data, the second volume data comprising a plurality of second samples, a number of the plurality of second samples being less than a number of the plurality of first samples and each of the plurality of second samples of the second volume data having a corresponding first sample of the first volume data, generating adjusted second volume data comprising a plurality of adjusted second regions, each adjusted second region being generated by performing a number of iterations of adjusting a voxel value of a second sample in a second region of the second volume data, wherein in each of the number of iterations, the method comprises determining a plurality of differences between a plurality of first opacity values in a first region of the first volume data and a plurality of corresponding second opacity values in the second region, and adjusting the voxel value of the second sample in the second region based on a weighted sum of the plurality of differences.

Certain embodiments provide a volume downsizing method. The method starts with a volume downsized by a simple algorithm (e.g. subsampling). Alpha (or other solidity) probes are generated by applying an opacity transfer function to the (potentially filtered, e.g. trilinearly) sampled voxel values, both in the original full-sized volume, and in the downsized volume. The subtracted differences between the full-sized and downsized alpha probe values are then weighted-summed within a footprint (e.g. 3×3×3) region of each downsized voxel. The weighting is based on the filtering strength of the central downsized voxel. So for trilinearly filtered voxels, the weighting would be high for alpha probes near the central downsized voxel, and lower for alpha probes near the edge of the footprint. The weighting is also optionally increased in the case of a large deviation between the full-sized/downsized volumes' alpha, such as by e.g. squaring the magnitude. Based on the sign of the weighted sum, the central downsized voxel's value is raised, lowered, or left the same (in the case of a zero or near-zero sum). This process is then repeated iteratively on the newly-modified volume instead of the starting volume, to attempt to converge on an improved quality of downsized volume.

This requires color/opacity transfer functions that only rise (by any sort of curve) from 0 to 1 alpha across their input range, or fall from 1 to 0 alpha across that range.

Instead of merely adding the (weighted) differences in alpha values between the full-sized and downsized volumes, a gradient for the alpha intensity (v.s. the input filtered volume voxel value) at the current point in the transfer function at each alpha probe position may be used, and the gradients may be weighted-added instead. This may provide support for more complex transfer functions.

When deciding how far to change each voxel (e.g. CT) value, large jumps may be made at first, and then when the sign of the weighted sum of alpha probes changes, smaller jumps may then be made in the other direction. This process may then be repeated with the jump size decreasing each time, until the weighted sum changes sign when the jump size has reached a sufficiently small value.

Voxel positions which have fully transparent or fully solid values in both the full-sized volume and the initial iteration of the downsized volume may be marked as not taking part in the hillclimbing algorithm. This may optimise a speed of the hillclimbing algorithm.

Voxel positions that attain very low alpha differences in each of their contributing alpha probes throughout their 3×3×3 footprint during hillclimbing may be marked as no longer taking part in the hillclimbing algorithm. This may optimise a speed of the hillclimbing algorithm.

Alpha probes that are only used by voxels which are not taking part in an iteration of the hillclimbing may be marked as not requiring further re-evaluation on that (and likely future) iterations. This may optimise a speed of the hillclimbing algorithm.

The algorithm may execute by uploading sub-regions of the volume (i.e. on a brick-by-brick basis), with an additional surrounding margin region to each brick also being uploaded (or re-used from a previous nearby brick upload). This may allow the algorithm to be run on the GPU in a situation where GPU memory usage must be kept low. The surrounding region to the brick (the ‘margin’) may be required as the 3×3×3 voxel footprints of each brick need voxel values from nearby regions of the volume, as these can affect the hillclimbing results of the brick being uploaded.

The terms “volume data”, “volumetric image data” and “volumetric imaging data,” as used herein, may be interchangeably used.

Whilst particular circuitries have been described herein, in alternative embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries.

Whilst certain embodiments have been described, these embodiments have been presented by way of example only, and are not intended to limit the scope of the invention. Indeed the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms and modifications as would fall within the scope of the invention.

1. A volumetric imaging data processing apparatus comprising processing circuitry configured to:
receive first volume data comprising a plurality of first samples;
generate second volume data based on the first volume data, the second volume data comprising a plurality of second samples, a number of the plurality of second samples being less than a number of the plurality of first samples and each of the plurality of second samples of the second volume data having a corresponding first sample of the first volume data;
generate adjusted second volume data comprising a plurality of adjusted second regions, each adjusted second region being generated by performing a number of iterations of adjusting a voxel value of a second sample in a second region of the second volume data, wherein in each of the number of iterations, the processing circuitry is configured to:
determine a plurality of differences between a plurality of first opacity values in a first region of the first volume data and a plurality of corresponding second opacity values in the second region; and
adjust the voxel value of the second sample in the second region based on a weighted sum of the plurality of differences.

2. The apparatus of claim 1, wherein the processing circuitry is configured to:
determine the plurality of first opacity values in the first region based on a first transfer function applied to the plurality of first samples and an interpolation used to generate first volumetric imaging data between the plurality of first samples; and
determine the plurality of second opacity values in second region based on a second transfer function applied to the plurality of second samples and an interpolation used to generate second volumetric imaging data between the plurality of second samples.

3. The apparatus of claim 2, wherein each difference of the plurality of differences comprises a subtracted difference between an average value of a group of the plurality of first opacity values and an average value of a corresponding group of the plurality of second opacity values.

4. The apparatus of claim 2, wherein each difference of the plurality of differences comprises a subtracted difference between at least one first opacity value of the plurality of first opacity values and at least one corresponding second opacity value of the second plurality of opacity values.

5. The apparatus of claim 1, wherein each of the plurality of differences comprises a gradient between a first opacity value of a first transfer function at a first position in the first region and a second opacity value of a second transfer function at a second position in the second region, wherein the second position in the second region corresponds to the first position in the first region.

6. The apparatus of claim 1, wherein a weighting of the weighted sum of differences is based on at least one of:
a position in the first and second regions at which each of the plurality of differences is determined relative to the second sample; and/or
a deviation between a first opacity value of the plurality of first opacity values and a corresponding second opacity value of the plurality of second opacity values.

7. The apparatus of claim 6, wherein the processing circuitry is configured to assign a weighting of zero to at least one of the plurality of differences determined at a position adjacent to at least one other second sample in the second region.

8. The apparatus of claim 1, wherein the processing circuitry is configured to adjust the voxel value of the second sample by:
increasing or decreasing the voxel value of the second sample based on a sign of the weighted sum of differences.

9. The apparatus of claim 1, wherein in each iteration, the processing circuitry is configured to adjust the voxel value of the second sample relative to a previous voxel value of the second sample.

10. The apparatus of claim 1, wherein in a first iteration, the processing circuitry is configured to:
adjust the voxel value of the second sample by an amount;
determine whether a predetermined metric has been met;
in response to a determination that the predetermined metric has been met, maintain a current voxel value of the second sample; or
in response to a determination that the predetermined metric has not been met, perform a next iteration of adjusting a voxel value of the second sample.

11. The apparatus of claim 10, wherein in each subsequent iteration, the processing circuitry is configured to:
determine whether a sign of the weighted sum of the plurality of differences has changed; and
in response to a determination that the sign of the weighted sum of the plurality of differences has changed, reduce an amount of adjustment to be applied to the voxel value of the second sample in a next iteration relative to an amount of adjustment applied to the voxel value of the second sample in a current iteration.

12. The apparatus of claim 11, wherein in each subsequent iteration, the processing circuitry is configured to:
determine whether a predetermined metric has been met;
in response to a determination that the predetermined metric has been met, maintain a current voxel value of the second sample; or
in response to a determination that the predetermined metric has not been met, perform a next iteration of adjusting the voxel value of the second sample.

13. The apparatus of claim 1, wherein the processing circuitry is configured to:
only adjust the voxel value of the second sample, when a combined total of the plurality of differences is above a threshold value, each of the plurality of differences comprising an absolute difference; and
maintain a current voxel value of the second sample, when, in at least one of the number of iterations, each of the plurality of differences is below or equals the threshold value.

14. The apparatus of claim 13, wherein when the current voxel value of the second sample is maintained, the processing circuitry is configured to maintain one or more of the plurality of second opacity values associated with the second sample.

15. The apparatus of claim 13, wherein when a voxel value of two or more adjacent second samples of the plurality of second samples is maintained, the processing circuitry is configured to maintain one or more of the plurality of second opacity values, the one or more of the plurality of second opacity values being determined at one or more positions between the two or more adjacent second samples of the plurality of second samples.

16. The apparatus of claim 1, wherein the processing circuitry is configured to:
detect whether the plurality of first opacity values in the first region are the same; and
in response to a determination that the plurality of first opacity values in the first region are the same, maintain the voxel value of the second sample in the second region, wherein the plurality of first opacity values in the first region each comprise a fully transparent opacity value or a fully opaque opacity value.

17. The apparatus of claim 1, wherein the processing circuitry is configured to perform a rendering process on the adjusted second volume data.

18. The apparatus of claim 1, wherein the first volume data comprises a plurality of first regions and the processing circuitry is configured to successively:
receive at least one of the plurality of first regions;
generate a second region based on the at least one of the plurality of first regions; and
generate an adjusted second region by performing the number of iterations of adjusting a voxel value of a second sample in the second region.

19. The apparatus of claim 18, wherein each of the plurality of first regions is surrounded by a margin region, the margin region comprising one or more first samples from one or more neighbouring first regions of the plurality of first regions.

20. A volumetric imaging data processing method comprising:
receiving first volume data comprising a plurality of first samples;
generating second volume data based on the first volume data, the second volume data comprising a plurality of second samples, a number of the plurality of second samples being less than a number of the plurality of first samples and each of the plurality of second samples of the second volume data having a corresponding first sample of the first volume data;
generating adjusted second volume data comprising a plurality of adjusted second regions, each adjusted second region being generated by performing a number of iterations of adjusting a voxel value of a second sample in a second region of the second volume data, wherein in each of the number of iterations, the method comprises:
determining a plurality of differences between a plurality of first opacity values in a first region of the first volume data and a plurality of corresponding second opacity values in the second region; and
adjusting the voxel value of the second sample in the second region based on a weighted sum of the plurality of differences.
